(19) United States
(12) Patent Application Publication
(10) Pub. No.: US 2015/0024841 A1
(43) Pub. Date: Jan. 22, 2015

(54) GAMING MACHINE & METHOD OF PLAY

(71) Applicant: Atlas Gaming Technologies Pty. Ltd., Port Melbourne (AU)

(72) Inventors: DANIEL JULIO MONTENEGRO, Port Melbourne (AU); Zenja Solaja, Port Melbourne (AU)

(73) Assignee: Atlas Gaming Technologies Pty. Ltd., Port Melbourne (AU)

(21) Appl. No.: 14/244,511

(22) Filed: Apr. 3, 2014

(30) Foreign Application Priority Data
Apr. 29, 2013 (AU) AU2013901491

(51) Int. Cl. G07F 17/32; G06F 3/041

(52) U.S. Cl. CPC G07F 17/3209; G06F 3/041; G07F 17/3211
USPC 463/31

(57) ABSTRACT

A gaming machine includes a touch screen display operable to display images and to register a player's touch input. It may also include a memory and a game controller configured to access the memory. The game controller may also control generation and display of the images and to process input received via the touch screen display. The game controller may be configured to detect a touch input and determine if the touch input is a valid touch input or an invalid touch input. When the touch input is determined to be an invalid touch input, the game controller may determine a location of the invalid input and apply an effect to the displayed image at the determined location.

### CROSS-REFERENCE TO RELATED APPLICATIONS

The present application claims priority from Australian Provisional Patent Application No 2013901491 filed on 29 Apr. 2013, the content of which is incorporated herein by reference.

### TECHNICAL FIELD

Described embodiments relate to an improvement to a gaming machine and an improved method of game play on a gaming machine or a network of gaming machines.

### BACKGROUND

It is widely known that in a gaming system, in its very basic form, a player places a wager and the gaming system produces a game play outcome that determines whether the player wins or loses the wager. The outcome is generated by the gaming machine's random number generator, and is presented to the player on the gaming machine display device as a display of graphics and animations.

The player may be able to interact with the gaming machine in a number of ways; for example by pressing mechanical buttons or switches, or by pressing areas of a touch screen. In one instance where a gaming machine receives player input from a touch screen, a voltage drop is created when a player's finger touches the screen. The gaming machine's software processes the the x and y coordinates of the location of this voltage drop and orders the ensuing action.

The gaming machine's software may generate new graphics, animations or sounds in response to the touch by the player, and the location of the touch is used to determine the command that the player intended to convey by the touch. The internal software state may be altered to reflect the new state of the game after the touch. For instance, a touch screen icon representing a button may transition from a raised representation to a lowered representation, as if the button has been pressed down, and the software will act on the virtual button press by executing the command that corresponds to the button.

A physical mechanical button has built in feedback mechanism that allows the player to know whether or not it has been pressed. For example, as the player must use physical force to push the switch or button, the player will feel the response from the underlying spring mechanism, and may hear the sound of the button being engaged. Furthermore, the button may remain in a lowered position after a press, giving a visual indication of its state. There is no confusion with the player as to whether the button was actually pressed.

Touch screens do not provide any physical feedback. Typically, the gaming machine software will present two graphical states for each touch screen icon, a deselected and a selected state. This graphical display indicates to the player that the gaming machine successfully processed the players input. However, if the player touches a region of the screen with no virtual button, no feedback is given as to whether the software processed the players input. When the touch screen is mis-calibrated, there is a possibility that the touch screen input coordinates as interpreted by the gaming machine software do not match the physical touch screen coordinates.

It is desired to address or ameliorate one or more shortcomings or disadvantages associated with prior methods of game play on a gaming machine or a network of gaming machines, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

A gaming machine is provided comprising:

a touch screen display operable to display images and to register a player's touch input;

a memory;

a game controller configured to access the memory, control generation and display of the images and to process input received via the touch screen display, the game controller further configured to:
detect a touch input and determine if the touch input is a valid touch input or an invalid touch input; and
when the touch input is determined to be an invalid touch input, determine a location of the invalid input and apply an effect to the displayed image at said determined location.

Preferably the effect is a player detectable effect.

The effect applied to the displayed image at said determined location may depend on the game being played, or the particular screen displayed. The game controller may be further configured to select an effect according to whether the touch input is a valid touch input or an invalid touch input. The game controller may be further configured such that when the touch input is determined to be a valid touch input, to determine a location of the valid input and apply an effect to the displayed image at said determined location.

Effects may include but not be limited to one or a combination of an animation effect, a ripple effect, an audio effect, a shading effect, a shadow effect, a colour change effect, a sparking effect, a glow effect, a spin effect, a zoom effect, a rain effect, a transparency effect, or another visually perceptible effect. Effects able to be selected to indicate a valid input may be different from effects able to be selected to indicate an invalid input. In one embodiment, the game controller is configured to select an effect to indicate a valid input from a first set of effects and to select an effect to indicate an invalid input from a second set of effects, where the first and second subsets of effects are discrete sets.

An applied effect may exist for a predetermined period of time, for example a second, a few seconds or several seconds. The game controller may be further configured to dissipate or dissolve the effect applied to a displayed image in response to an invalid touch input and/or a valid touch input. The applied effect may disappear after a predetermined period of time. Thereafter, the game controller may be configured to restore the displayed image at said determined location.

Some embodiments relate to a gaming system comprising at least one gaming machine as described above and at least one server system in communication with the game controller of the at least one gaming machine.

Some embodiments relate to a method of game play executed by a computerised game controller, the method comprising:

registering a player's touch input via a touch screen display in response to displayed images;

determining if the touch input is a valid touch input or an invalid touch input;

when the touch input is determined to be an invalid touch input, determining a location of the invalid input on the touch screen display; and

applying an effect to the displayed image at said determined location.

The method of game play may further comprise selecting an effect, where the effect is at least one of an animation effect, a ripple effect, an audio effect, a shading effect, a shadow effect, a colour change effect, a sparking effect, a glow effect, a spin effect, a zoom effect, a rain effect, and a transparency effect.

The method of game play may further comprise determining the touch input to be an valid touch input, and in response determining a location of the valid input and applying an effect to the displayed image at said determined location.

The method of game play may further comprise applying distinct effects to each of a valid input and an invalid input.

The method of game play may further comprise dissipating the effect applied to a displayed image in response to an invalid touch input and/or a valid touch input.

The method of game play may further comprise restoring the displayed image at said determined location once the applied effect has dissipated.

Some embodiments relate to computer-readable storage storing executable program code that, when executed by a game controller, causes the game controller to perform the methods described above and/or implement the features and functions of the gaming machine or gaming system described above.

A computer-readable medium is provided, the medium storing machine-readable instructions to cause a processor of a gaming machine to:

register a player's touch input via a touch screen display in response to displayed images;

determine if the touch input is a valid touch input or an invalid touch input;

when the touch input is determined to be an invalid touch input, determine a location of the invalid input on the touch screen display; and

apply an effect to the displayed image at said determined location.

The computer-readable medium may store machine-readable instructions to cause the processor of the gaming machine to select an effect, where the effect is selected from one or a combination of an animation effect, a ripple effect, an audio effect, and a shading effect.

The computer-readable medium may store machine-readable instructions to, upon determining the touch input to be an valid touch input, cause the processor of the gaming machine to determine a location of the valid input and apply an effect to the displayed image at said determined location.

The computer-readable medium may store machine-readable instructions to cause the processor of the gaming machine to apply distinct effects to each of a valid input and an invalid input.

The computer-readable medium may store machine-readable instructions to cause the processor of the gaming machine to dissipate the effect applied to a displayed image in response to an invalid touch input and/or a valid touch input.

The computer-readable medium may store machine-readable instructions to cause the processor of the gaming machine to restore the displayed image at said determined location once the applied effect has dissipated.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF DRAWINGS

In order that the present invention may be more clearly ascertained, embodiments will now be described, by way of example, with reference to the accompanying drawing, in which:

FIG. 1 shows a perspective view of a gaming machine;

FIG. 2 shows a block diagram of a game logic circuit of the gaming machine illustrated in FIG. 1;

FIG. 3 shows a block diagram of functional components of a gaming system incorporating gaming machines illustrated in FIG. 1;

FIG. 4 shows a block diagram of game logic circuitry of the gaming machine illustrated in FIG. 1 that deals with frame buffering;

FIG. 5 shows some software components in the software executable by game logic circuitry of the gaming machine illustrated in FIG. 1;

FIG. 6 shows some components of the display server of the gaming machine illustrated in FIG. 1;

FIG. 7 shows a flow diagram setting out the process by which a touch event is triggered on the gaming machine illustrated in FIGS. 1; and

FIG. 8 shows a flow diagram setting out the process by which an effect is applied to an invalid touch on the gaming machine illustrated in FIG. 1.

### DESCRIPTION OF EMBODIMENTS

Described embodiments generally relate to a gaming machine and an improved method of game play on a gaming machine or a network of gaming machines.

The gaming system can take a number of different forms. In a first form, a stand-alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in standalone gaming machine mode, “thick client” mode or “thin client” mode depending on the game being played, operating conditions, and so on. Other variations will be apparent to persons skilled in the art.

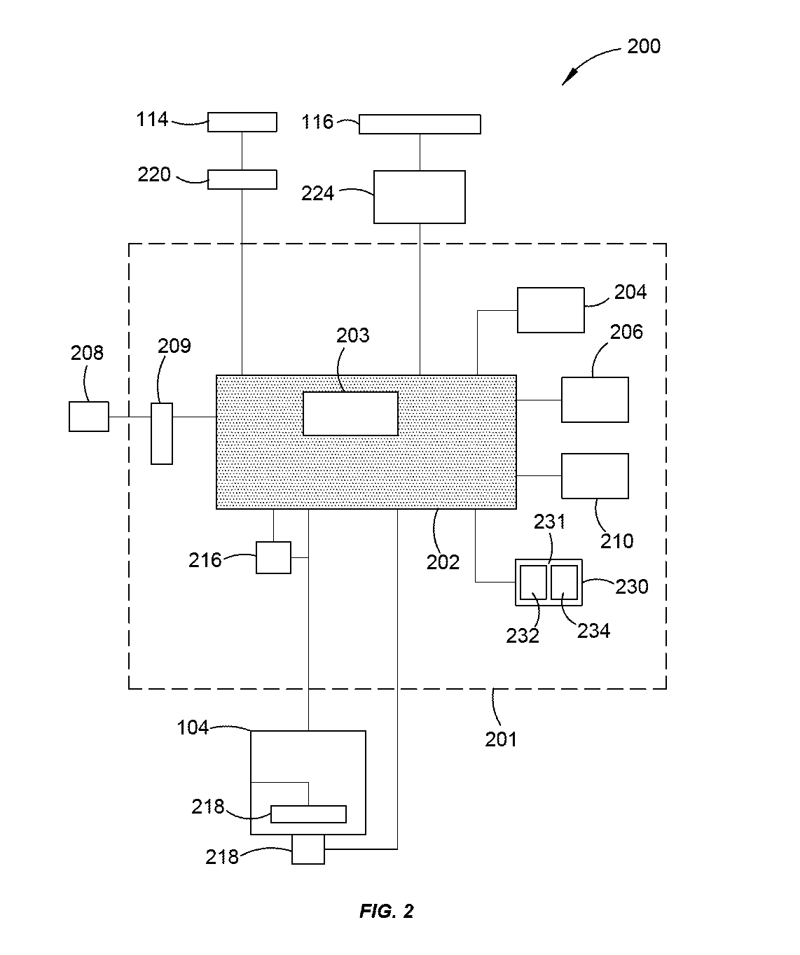

One or more of the method steps described in this disclosure may be implemented by executable instructions and parameters 232, 234 (See FIG. 2), stored in the memory 204, 206, 230 (See FIG. 2), that may form software embodiments of the system 100. These instructions 232, 234 that form the system 100 may be executed by the CPU 202 (See FIG. 2) or any other processor. Further, the processor 202, the memory 204, 206, 230, the instructions 232, 234 stored therein, or a combination thereof may serve as a means for performing one or more of the method steps described herein.

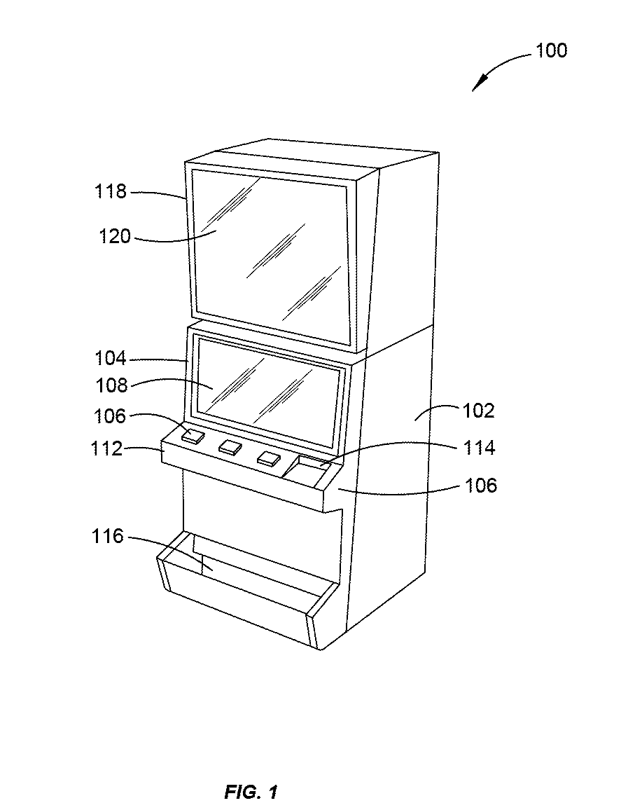

Irrespective of the form, the gaming system 100 has several core components. At the broadest level, the core components are a player interface in the form of a touch screen 108 as illustrated in FIG. 1 and a game controller 200 as illustrated in FIG. 2. The player interface is arranged to enable manual interaction between a player and the gaming system and for this purpose includes the input/output components required for the player to enter instructions and play the game.

Referring now to FIG. 1, reference numeral 100 generally designates a stand-alone gaming system including a game. Hereinafter, the stand-alone gaming system 100 will be referred to as a gaming machine.

The gaming machine 100 includes a console 102 which contains all or most components required to implement a game play whereby a player wins or loses a wager. Access to the components is by way of a hinged door 105. Moulded to the exterior of the console 102 is a display means in the form of at least one visual display unit 104 on which one or more games is played. The video display unit 104 may be implemented as a liquid crystal display, a plasma screen, as a cathode ray screen device or the like. Whilst the console 102 illustrated in FIG. 1 shows a single visual display unit 104, there can be more than one visual display unit on a typical machine. What is displayed on the visual display unit 104 will depend on what the intended goal of the unit is in relation to the player and any other potential participants in the gaming system.

The gaming machine includes a tactile input for a player to interact via touch with the gaming machine 100. In this example, the tactile input is in the form of a combination of pushbuttons 106 and a touch screen 108 for enabling a player to play one or more games. The touch screen is an electronic visual display that can detect the presence and location of a touch within the display area. The touch screen 108 is used during the game play between start of a game and the end of a game. A game is considered to have started once a wager is placed and considered complete once the wager has been lost or won. Certain functions of the pushbutton are: initiation of game play, credit output, gameplay selection, completion of gameplay etc. A midtrim 112 of the machine 100 houses the pushbuttons 106.

The tactile input may optionally or further include a joystick comprising of a stick that pivots on a base and reports its angle or direction to the device it is controlling. The tactile input may optionally or further include a trackpad/touchpad being a pointing device featuring a tactile sensor to translate the motion and position of a user's fingers to a relative position on screen.

It should be appreciated that tactile input may include any suitable device that enables the player to produce an input signal that is received by the processor. Tactile input in the form of pushbuttons 106 and/or regions on touch screen 108 may include a one bet button, a max bet button, or a repeat the bet button. With a one bet button for instance, the player places a bet by pushing the one bet button. The player may increase the bet by one credit each time the player pushes the bet one button.

The midtrim 112 also houses credit input device including a bill collector 114. The credit input device may further include a coin input chute, a card and/or ticket reader, a magnetic reading head for reading a magnetic stripe card, an electronic reader for a proximity card, a near field communications reader or any other form of electronic, wireless or contact that can input credit to the gaming machine.

A credit dispenser in the form of a coin tray 116 is mounted beneath the console 102 and is provided for cash payouts from the machine 100 to the player. A hopper device (not shown) is provided which dispenses coins, or tokens equal to the amount of credit currently on the machine, into the coin tray 116. Aside from the coin tray 116, the credit dispenser may also include a ticket dispenser for issuing a ticket dispensed by a printer which the user can redeem for cash, a note dispenser, a near field communications transmitter or means to enable remote credit transfer. It should be appreciated that any suitable payout mechanisms, such as funding to the player's electronically recordable identification card or smart card, may be implemented in accordance with the gaming machine disclosed herein.

The gaming machine 100 includes a top box 118 on which artwork 120 is carried in the form of electronic visual display units. The artwork 120 could also be made from physical materials such as paper, plastic banners or posters. The artwork 120 may have generic information related to the machine or gaming system or the artwork 120 be specifically made for a particular game to be played on the machine 100. Whilst the artwork 120 is shown as being carried on the top box 118 the art work 120 can also be positioned in or on the bottom panel of the door 105, or any other part of the gaming machine 100 visible to the player.

The gaming machine 100 further includes an auditory unit in the form of speakers (not shown) to provide auditory feedback to the player of the gaming machine 100.

Referring to FIG. 2 of the drawings, game logic circuitry 200 is illustrated. The game logic circuitry 200 includes a gaming controller 201 (otherwise referred to as a logic cage) designated by the dashed lines. As will be appreciated by those skilled in the gaming industry, the logic cage 201 includes a box-like mechanical structure that has slots to guide logic cards into the proper location for electronically plugging into a backplane mounted at the rear of the cage structure. The backplane has connectors for accepting mating connectors on the logic cards. The logic cage and associated cards form one of the basic components of the gaming machine 100 and is securely housed within the cabinet of the gaming machine 100.

Central to the logic cage is a central processing unit 202 such as a processor, a microcontroller-based platform, a suitable integrated circuit, or one or more application-specific integrated circuits (ASIC's). The processor 202 is in communication with or operable to access or to exchange signals with at an outcome evaluator 203, RAM 204, ROM 206, a non-volatile memory in the form of a compact flash 230, an audio output 208 via an audio control module 209, and a random number generator 210. The audio control module 209 has its own digital signal processor, analogue to digital converters, amplifiers and other circuitry necessary to broadcast the output from the speakers. RAM 204 may include non-volatile RAM (NVRAM), magnetic RAM (MRAM), ferroelectric RAM (FeRAM), and other forms as commonly understood in the gaming industry.

Compact flash memory 230 is physically secured within a slot in the logic cage 201. In one embodiment, the compact flash memory 230 is physically secured inside the logic cage within game logic circuitry 200 by a mechanical locking mechanism. Compact flash memory 230 is partitioned 231 into two parts. A first part comprises a game software module 232 and a second part comprises a metering information module 234.

The processor 202 runs executable code residing in game software module 232 of compact flash 230 that facilitates play of the game by a player through the display device and/or push buttons and touch sensors mounted in the screen of the display. Metering information module 234 contains the gaming machine parameters which include values that would usually be stored on a hard meter. The values in metering information module 234 are only ever incremented, and cannot be reset or decremented. The only way to alter the values stored is by running the executable code stored in game software module 232, which is executed by processor 202. The executable code further interacts with the credit dispenser 116 via a payout mechanism 224 and the auditory output 208. The game software module 232 contains the rules of the game, the sequence of gameplay, communicates with external systems, monitors peripheral equipment, maintain integrity of the software code, etc. The processor 202 continually checks for error conditions.

A program which implements the game logic circuitry 200 and the user interface is further run by the central processing unit 202. The processor 202 forms part of a controller 216 that drives the screen of the video display unit 104 and that receives input signals from sensors 218. The sensors 218 include sensors associated with the push buttons and touch sensors mounted in the screen of the video display unit 104. The controller 214 also receives input pulses from mechanisms 220 and 224 to determine whether or not a player has provided sufficient credit from either payment device 114 or payment device 116 to commence playing.

In one embodiment, a player may insert an identification card into a card reader (not shown) of the gaming machine 100. Such an identification card may be a smart card having a programmed microchip, a coded magnetic strip, or coded rewritable magnetic strip, wherein the programmed microchip or magnetic strips are coded with a player's identification, credit totals (or related data), and/or other relevant information. In another embodiment, a player may carry a portable device, such as a mobile phone, a radio frequency identification tag, or any other suitable wireless device, that communicates a player's identification, credit totals (or related data), and other relevant information to the gaming device.

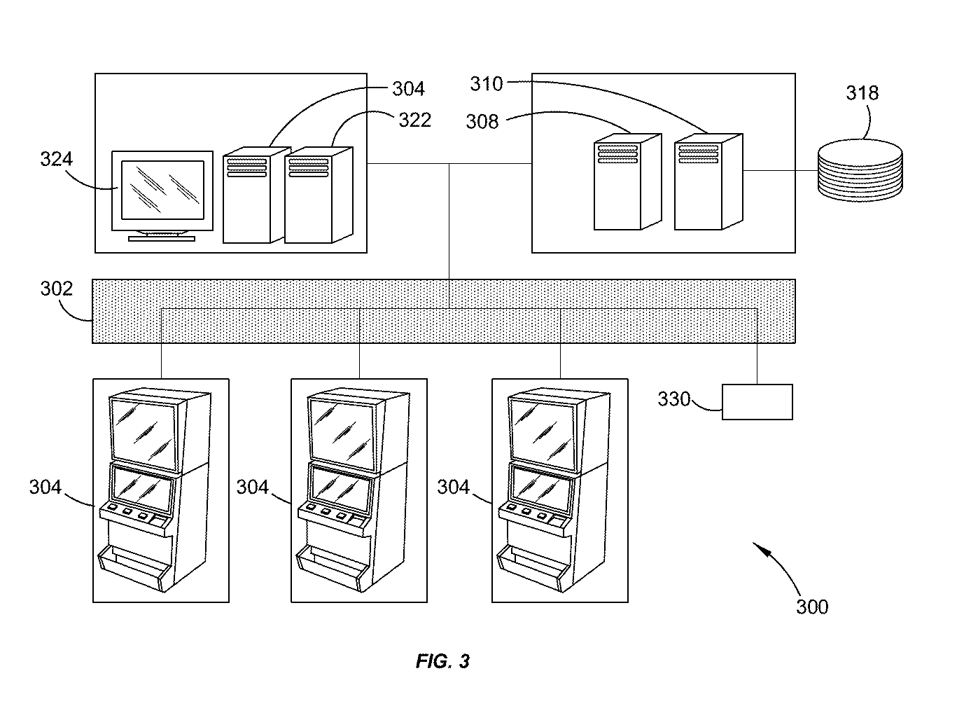

FIG. 3 shows a gaming system 300 in accordance with an alternative embodiment. The gaming system 300 includes a network 302, which for example may be an Ethernet network. The network 302 may also comprise a wide area network (“WAN”), the plain-old-telephone-system (“POTS), a local area network (“LAN”), a wireless LAN, the Internet, or any combination of these and other types of networks. Gaming machines 304 are connected to the network 302. The gaming machines 304 provide a player operable interface and may be the same as the gaming machines 100 shown in FIG. 1 or may have simplified functionality depending on the requirements for implementing game play.

In a thick client embodiment, game server 308 implements part of the game played by a player using a gaming machine 304 and the gaming machine 304 implements part of the game. With this embodiment, as both the game server 308 and the gaming device implement part of the game, they collectively provide a game controller. A database management server 310 may manage storage of game programs and associated data for downloading or access by the gaming devices 304 in a database 318.

In a thin client embodiment, game server 308 implements most or all of the game played by a player using a gaming machine 304 and the gaming machine 304 essentially provides only the player interface. With this embodiment, the game server 308 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 300, including for example a gaming floor management server 320, and a licensing server 322 to monitor the use of licenses relating to particular games. An administrator terminal 324 is provided to allow an administrator to run the network 302 and the devices connected to the network.

The gaming system 300 may communicate with other gaming systems, other local networks, for example a corporate network, and/or a wide area network such as the Internet, for example through a firewall 330.

Persons skilled in the art will appreciate that in accordance with known techniques, functionality at the server side of the network may be distributed over a plurality of different computers. For example, elements may be run as a single “engine” on one server or a separate server may be provided. For example, the game server 308 could run a random generator engine. Alternatively, a separate random number generator server could be provided. Further, persons skilled in the art will appreciate that a plurality of game servers could be provided to run different games or a single game server may run a plurality of different games as required by the terminals.

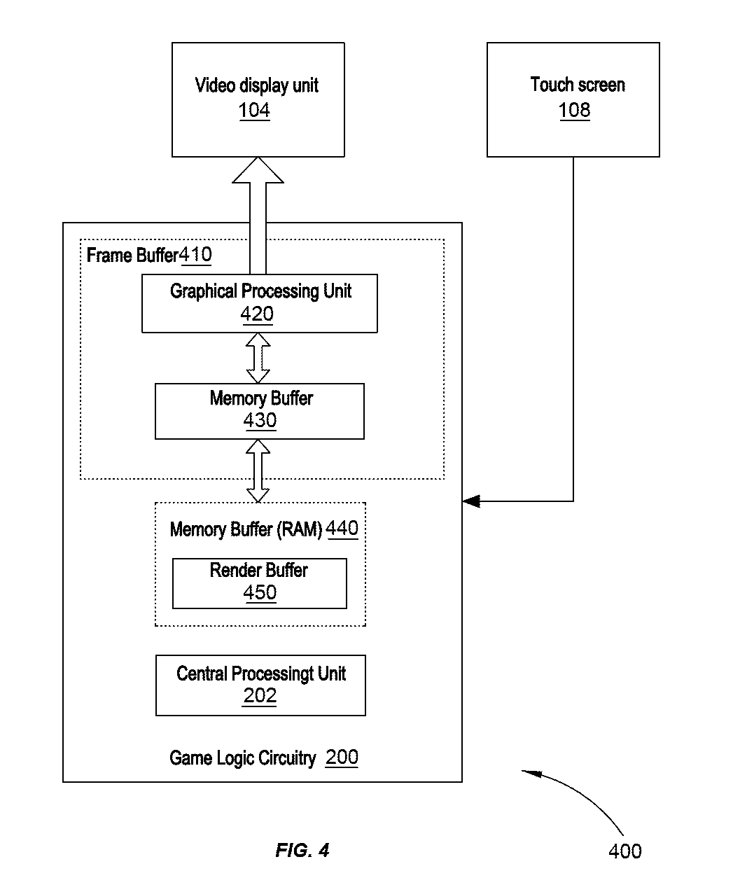

Referring now to FIGS. 4 to 8, features and functions of game machine 100 and gaming system 300 are described in further detail with respect to display images 400 and 500 generated by execution of code comprised in the game software module 232.

Referring to FIG. 4, a section 400 of game logic circuitry 200 of FIG. 2 is depicted. This section specifically deals with frame buffering. When the user presses on touch screen 108, a voltage drop is generated which is then detected by the game logic circuitry 200, which interprets the x and y coordinates of the location that has been pressed. The software executed by game logic circuitry 200 directs all graphic operations to memory buffer 430, which is subsequently sent to graphical processing unit 420 to display on video display unit 104. Memory buffer 430 and graphical processing unit 420 collectively make up frame buffer 410 where by rendering can be drawn directly to the display screen. Post processing effects can be added to the frames in frame buffer 410 before they are forwarded for display. Alternatively, the software may direct the data to render buffer 450 for intermediate processing before sending it to frame buffer 410.

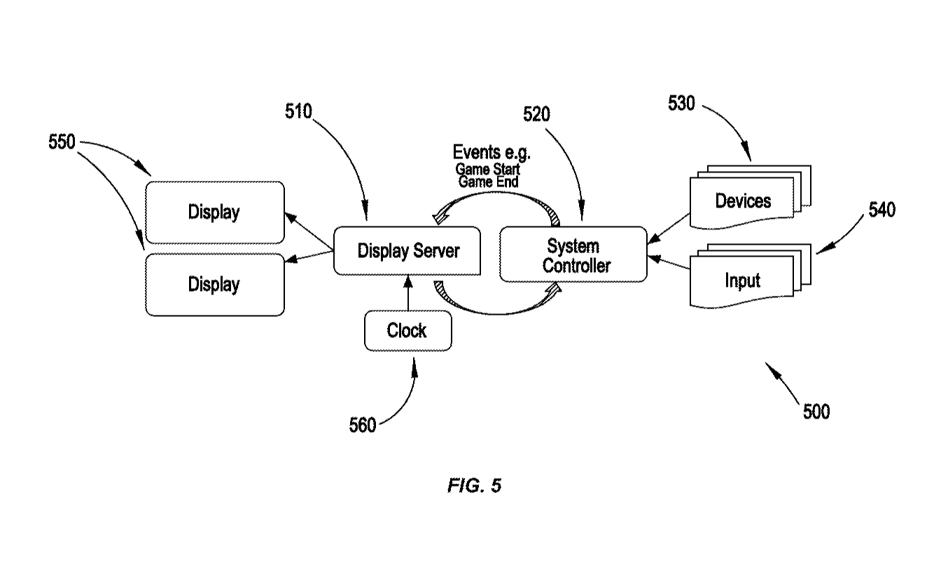

FIG. 5 depicts certain of the software components in the software module executable by game logic circuitry 200. System controller 520 communicates instructions to display server 510 based on data from input sources 540, and display server 510 subsequently communicates corresponding data to one or more displays 550.

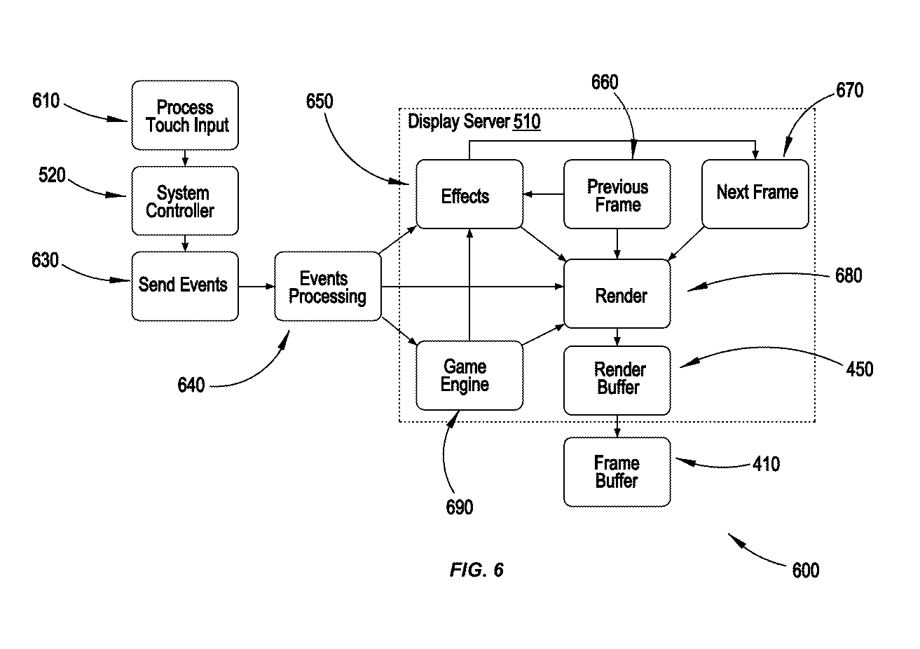

FIG. 6 displays the components of display server 510 and interactions between certain of the components in more detail. In the illustrated embodiment, display server 510 contains game engine 690 and render buffer 450. Any touches of the display screen by the user are processed by module 610, and sent to system controller 520. If the input triggers an event, system controller 520 sends the event at 630, and the event is processed at 650. The processing is done by display server 510.

When rendering an effect, instead of rendering direct to frame buffer memory, rendering instructions target an interim render buffer 450. When the instructions to render the final scene requiring a post rendering effect is complete, the interim render buffer 450 is then rendered to the frame buffer 410 using a post-render effect. The addition of post-render effects occurs in the effects module 650 and once complete is passed to the frame buffer 410, where the data is then displayed.

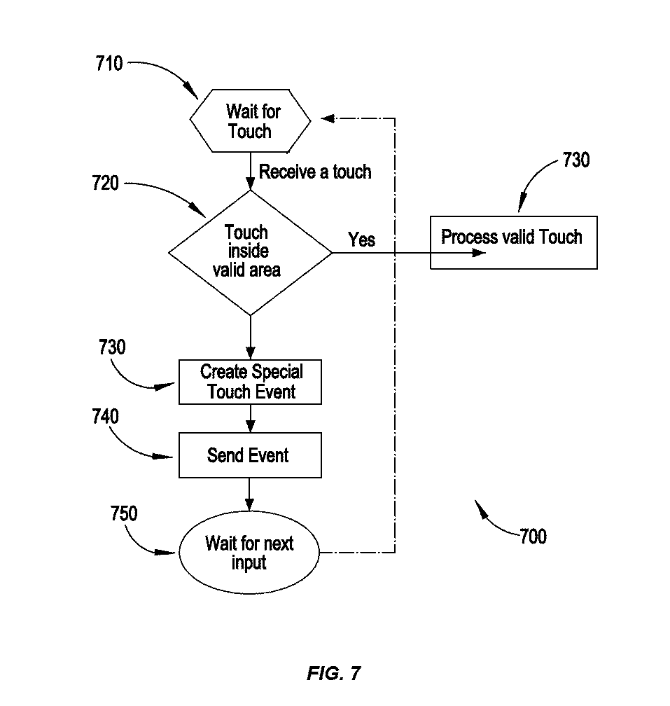

FIG. 7 shows flow diagram 700 setting out the process by which a touch event is triggered. At 710, system controller 520 waits for a touch to touch screen 108. When a touch is sensed, system controller 520 determines at 720 whether or not the touch was valid, where a valid touch is one that falls on an area of touch screen 108 corresponding to a virtual input presented on display screen 104. Where the touch is valid, system controller 520 proceeds to process the touch at 730, based on any command that the touch triggers. Where the touch is invalid, system controller 520 creates a special touch event at 730, and sends this event to game engine 690 (FIG. 6) for processing at 740. System controller 520 then waits for the next input at 750 when the process repeats itself.

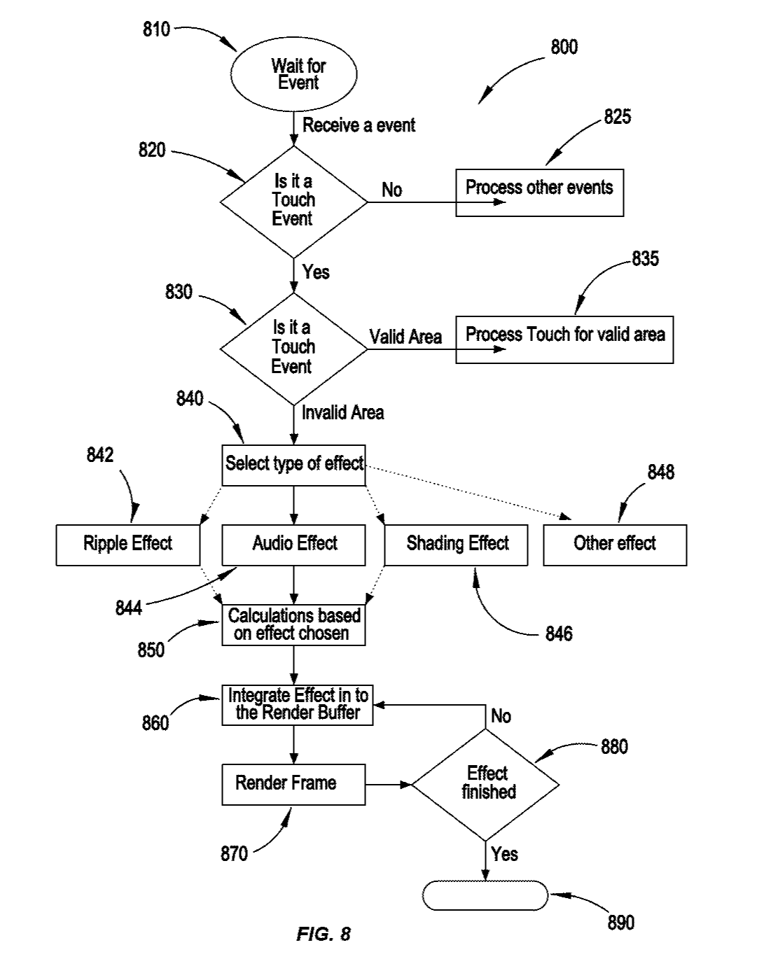

FIG. 8 shows flow diagram 800 setting out the process by which an effect is applied to an invalid touch. Display server 510 waits for an event to be sent by system controller 520 at 810. When an event is received, system controller 520 determines whether or not it was a touch event at 820, and non-touch events are processed appropriately at 825. If the event is a touch event, system controller 520 next determines whether the touch occurred in a valid area at 830. Valid touches are processed at 835. If the touch event occurred in an invalid portion of touch screen 108, an effect is applied to indicate this to the user. The effect may vary based on the game being played, or the screen in view. The appropriate effect is selected at 840.

In the illustrated embodiment, the effect may be ripple effect 842, audio effect 844, shading effect 846 or other effect 848. The effect graphics varies with the location of the touch input and the distance from touch input and time. For example a water ripple effect can be displayed from the touch point dissipating out in a circular path and eventually disappearing.

Display server 510 the performs the calculations at 850 that are required to implement the effect. The effect is integrated into render buffer 450 at 860, and the frame is rendered at 870. If the effect is complete at this stage, the process moves to step 890 where display server 510 returns to waiting for an event at 810. Alternatively, if the effect is still continuing, the process loops back to 860, where the next part of the effect is integrated into render buffer 450 and the next frame is rendered at 870.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

While the foregoing description has been provided by way of example of the preferred embodiments of the present invention as presently contemplated, which utilise gaming machines of the type found in casinos, those skilled in the relevant arts will appreciate that embodiments of the present invention also may have application to internet gaming and/or have application to gaming over a telecommunications network, where mobile handsets are used to display game outcomes and receive player inputs. Such mobile devices include smart phones, notebooks, tablets, iPads and laptop computers. For instance free mobile device games may be offered for download and play on a players personal mobile device as a bonus game play. In such an embodiment the gaming machine may comprise a power interface to enable interaction between the respective devices and/or a communication or wireless interface to enable data transfer. During game play, the gaming machine may be configured to send information to the player's personal mobile device.

Certain steps in the processes or process flows described in this disclosure naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention.

1. A gaming machine is provided comprising:
a touch screen display operable to display images and to register a player's touch input;
a memory;
a game controller configured to access the memory, control generation and display of the images and to process input received via the touch screen display, the game controller further configured to:
detect a touch input and determine if the touch input is a valid touch input or an invalid touch input; and
when the touch input is determined to be an invalid touch input, determine a location of the invalid input and apply an effect to the displayed image at said determined location.

2. A gaming machine according to claim 1, wherein the effect is a player detectable effect.

3. A gaming machine according to claim 2, wherein the effect is at least one of an animation effect, a ripple effect, an audio effect, a shading effect, a shadow effect, a colour change effect, a sparking effect, a glow effect, a spin effect, a zoom effect, a rain effect, and a transparency effect.

4. A gaming machine according to claim 3, wherein the game controller is further configured when the touch input is determined to be an valid touch input, to determine a location of the valid input and apply an effect to the displayed image at said determined location.

5. A gaming machine according to claim 4, wherein the game controller is further configured to apply distinct effects to each of a valid input and an invalid input.

6. A gaming machine according to claim 4, wherein the game controller is further configured to dissipate the effect applied to a displayed image in response to an invalid touch input and/or a valid touch input.

7. A gaming machine according to claim 6, wherein the game controller is further configured to restore the displayed image at said determined location once the applied effect has dissipated.

8. A computer-readable medium storing machine-readable instructions to cause a processor of a gaming machine to:
register a player's touch input via a touch screen display in response to displayed images;
determine if the touch input is a valid touch input or an invalid touch input;
when the touch input is determined to be an invalid touch input, determine a location of the invalid input on the touch screen display; and
apply an effect to the displayed image at said determined location.

9. A computer-readable medium according to claim 8, storing machine-readable instructions to cause the processor of the gaming machine to select an effect, wherein the effect is at least one of an animation effect, a ripple effect, an audio effect, a shading effect, a shadow effect, a colour change effect, a sparking effect, a glow effect, a spin effect, a zoom effect, a rain effect, and a transparency effect.

10. A computer-readable medium according to claim 8, storing machine-readable instructions to, upon determining the touch input to be an valid touch input, cause the processor of the gaming machine to determine a location of the valid input and apply an effect to the displayed image at said determined location.

11. A computer-readable medium according to claim 10, storing machine-readable instructions to cause the processor of the gaming machine to apply distinct effects to each of a valid input and an invalid input.

12. A computer-readable medium according to claim 11, storing machine-readable instructions to cause the processor of the gaming machine to dissipate the effect applied to a displayed image in response to an invalid touch input and/or a valid touch input.

13. A computer-readable medium according to claim 12, storing machine-readable instructions to cause the processor of the gaming machine to restore the displayed image at said determined location once the applied effect has dissipated.

14. A method of game play executed by a computerised game controller, the method comprising:
registering a player's touch input via a touch screen display in response to displayed images;
determining if the touch input is a valid touch input or an invalid touch input;
when the touch input is determined to be an invalid touch input, determining a location of the invalid input on the touch screen display; and
applying an effect to the displayed image at said determined location.

15. A method of game play executed by a computerised game controller according to claim 14, the method further comprising selecting an effect, where the effect is at least one of an animation effect, a ripple effect, an audio effect, a shading effect, a shadow effect, a colour change effect, a sparking effect, a glow effect, a spin effect, a zoom effect, a rain effect, and a transparency effect.

16. A method of game play executed by a computerised game controller according to claim 14, the method further comprising determining the touch input to be an valid touch input,and in response determining a location of the valid input and applying an effect to the displayed image at said determined location.

17. A method of game play executed by a computerised game controller according to claim 15, the method further comprising applying distinct effects to each of a valid input and an invalid input.

18. A method of game play executed by a computerised game controller according to claim 17, the method further comprising dissipating the effect applied to a displayed image in response to an invalid touch input and/or a valid touch input.

19. A method of game play executed by a computerised game controller according to claim 18, the method further comprising restoring the displayed image at said determined location once the applied effect has dissipated.
